(19) United States
(12) Patent Application Publication
(10) Pub. No.: US 2011/0207098 A1
(43) Pub. Date: Aug. 25, 2011

(54) SYSTEM FOR TREATING MENTAL ILLNESS AND A METHOD OF USING A SYSTEM FOR TREATING MENTAL

(76) Inventor: Maria Jakovljevic, Germiston (ZA)

(21) Appl. No.: 13/002,450

(22) PCT Filed: Jun. 24, 2009
(86) PCT No.: PCT/IB09/52705

§ 371 Date: Apr. 15, 2011

(30) Foreign Application Priority Data
Jul. 3, 2008 (ZA) 2008/05835
Jul. 3, 2008 (ZA) 2008/05836

(51) Int. Cl. G09B 19/00

(52) U.S. Cl. 434/236

(57) ABSTRACT

A system for providing treatment to a patient with a mental illness, the treatment system (200) including a communication interface to receive electronically information relating to monitored behaviour of a patient, a voice instruction module (152) having stored thereon at least one pre-defined voice instruction, the communication interface being operable to transmit electronically the voice instruction to the patient. The invention also provides for a method of treating a mental illness of a patient using the aforementioned system.

### BACKGROUND TO THE INVENTION

Traditional methods of diagnosing, assessing and treating psychological and psychiatric conditions (hereinafter “mental illness”) involves periodic clinical sessions in which a clinician attempts to obtain insights of a patient's condition by conducting interviews and, in some cases, conducting tests. These traditional methods are often very lengthy and, as a result, costly. Moreover, many mental illnesses and behaviour patterns are not easily diagnosed during a series of routine clinical visits because the condition or behaviour is situation-dependent and, thus, may not be observable in a clinical setting. Under such conditions, the identification and diagnosis of a mental illness or behaviour pattern becomes very subjective, often resulting in an even larger number of diagnostic clinical sessions and higher costs. Lower rates of diagnostic accuracy and treatment efficacy also result.

Many people suffering from a mental illness are unable to obtain clinical assistance because of the high cost of diagnosis and treatment. Further, even where cost is not a major deterrent, many people lose confidence in the clinical procedure and cease attending clinical sessions when treatment becomes difficult and lengthy.

Present therapies used in clinical psychology and psychiatry have been inadequate in treating psychosis and schizophrenia. Scientific findings give indications of partial success using different medications, psychoanalysis therapy, cognitive-behaviour treatment and community programmes. There is presently no generally accepted therapy, which is based on the use of technology. For example, a phenomenological approach points that the processing capacity of patients with regard to motion integration imposes a higher processing load on the patient. It doesn't highlight the use of a computer system which can aid the processing capability of the patient. There are no appropriate techniques and a computer system which can provide solutions treating psychological and psychiatric illnesses.

Patients suffering from psychosis, schizophrenia, or the like, often require, as part of their treatment, observation by a psychiatrist or therapist, so that the behaviour of the patient can be monitored, and if necessary, controlled.

### SUMMARY OF THE INVENTION

According to one aspect of the invention, there is provided a system for the treatment of a mental illness in a patient, wherein the system includes:

a patient system including a communication means for communicating a remote voice to the patient; and

a clinician system located remotely from the patient system for monitoring and analysing the remote voice treatment and to modify the remote voice treatment based on the analysis where necessary thereby to provide therapeutic treatment to the patient.

The system may include a communications link connectable in signal communication with the patient system and the clinician system for the exchange of signals between the patient system and the clinician system.

The clinician system may be a clinician computer workstation.

The system may include monitoring means in the form of a separate monitoring device that is connectable in signal communication with the clinician system.

According to another aspect of the invention, there is provided a method of treating a mental illness of a patient that includes the steps of:

treating the patient's mental illness by means of remote voice therapy;

monitoring and analysing the treatment while it takes place; and

modifying the treatment appropriately based on the analysis of the treatment.

The remote voice therapy may be an appropriate auditory stimulus depending on the mental illness being treated. Diagnosis of the patient's mental illness takes place before treatment by the method in accordance with the invention.

According to another aspect of the present invention, a method of treating a mental illness of a patient by means of remote voice therapy is provided which permits reassurance and self-healing in the patient who is diagnosed as having a mental illness.

The therapy may assist the patient in coping with the mental illness. The remote voice therapy may be tailored to provide appropriate therapeutic treatment of the patient.

The specific words provided by the remote voice therapy may have a positive and calming effect on the patient. After prolonged repeated use, the effect becomes a permanent component in the patient's healing process.

The invention may be used in the Clinical Psychology and Psychiatry fields.

Remote voice therapy (RVT) provide a base for the computer information systems Remote Voice Monitoring System (RVMS) may be used for various kinds of psychosis, preferably psychosis in an acute form. It may also be used for acute stages of schizophrenia.

Success of the therapy in accordance with the invention is dependent on a number of aspects such as: accurate usage thereof, and the age and educational level of the patient. RVT may be used together with suitable medical substances.

### GLOSSARY OF ABBREVIATIONS

RV: Remote voice

RVT: Remote voice therapy

RVTD: Remote voice transmission device

RVP: Remote voice program

RVTS: Radio Voice Transmission System

CVTS: Computer Voice Transmission System

The remote voice therapy (RVT) may be broadcast by a voice transmission device, which imitates programmed words and short messages aimed in guiding the patient in the treatment or recovery process. RVT motivates and supports the patient during the painful awaking process in real life situations. RVT helps in the re-learning process by taking the responsibility for sending appropriate auditory signals. This is necessary as patient energy, concentration and attention are not sufficient to receive complex external auditory stimuli and the patient keeps fighting against the pressure of partially received visual images of reality.

RVT helps to reconnect a patient to an object and place in reality. If this process of reconnection is interrupted, the patient has little chance of returning safely back to reality. If this process is not continuous (as learning is incremental and ‘momentum’ must be accumulated) the patient must start from the beginning, as there is little possibility of recalling information from the memory of the patient due to the patient's mental state.

RVT assists as a memory builder as it helps patients in unloading disconnected images from previous, and faulty, perception systems; and it allows the building of new perceptual habits.

The Stages of Psychosis and the Integration of Remote Voice Therapy

Certain stages of psychosis were identified and the remote voice therapy is applied modified, depending on the stage of psychosis on a continual basis. These stages are described below in a non-limiting manner

The first stage (self-recognition stage): Patients lack self-awareness and self-conciseness with no control of internal thought, which the patient perceives as an internal voice. The patient's perceptual habits are faulty and they have to rebuild their perceptual system. The faulty perceptual habits can take different forms (for example, trying to visualise too many stimuli at a time unit, avoiding the hearing and visualization process but stimuli are still encoded in the brain, too long visual fixation of a stimuli, voluntary avoidance of feeling own body parts). The patient's perception of his/her own body and movement may be impaired. The correct perceptual habits built with the help of RVT will allow the gradual control of body and movement perception. This aids in increasing self-awareness. Each part of the body may be voluntary integrated into the total body image with the help of remote voice (RV).

At this stage the patient needs frequent everyday exposure to the RVT in order to recognise self. This is a stage where programming instructions incorporated in the remote voice transmission device (RVTD) are necessary to practice new perceptual habits, self-orientation in space, self-awareness and self-consciousness. In this stage the patient is unable to judge the direction and distance of the remote voice which helps in the transmission of audio signals through RVMS.

The second stage (discovery of surroundings): is when RVT is necessary in order to reinforce previous learning and allow the patient to choose his own routes of movements in space, visit old places and visit people which where present during the development of his/her illness. The patient has a need to revisit old places, experience other persons acts from a different perspective (with a presence of self-awareness) as previous partial images have to be integrated and stored in the memory. The patient must get rid of the faulty numerous visual perceptual images, which places the patient under enormous pressure. At the same time learning how to speak and move in different circumstances takes place. The patient is sensitive to the distance and direction of the RV. The transmission of the RV at this stage is ideally from a further distance from the patient.

Third stage (social interactions; direct communications): The processes from previous stages are further reinforced and the patient now feels free to attempt more complex actions in a social environment, as she or he starts to use gradually direct communications. The help of a clinical assistant/volunteer, community, family and friends may aid the RVMS.

In addition to auditory stimuli the RVT now transfers visual images to aid learning through imitation and modelling. Remote auditory messages are transmitted less frequently as saturation points (for example, the level of self-awareness) have been reached based on performance indicators (see Remote Voice Programme).

There is no strict border between three stages. The principle of continuity, repetition and imitation are crucial for the recovery process.

According to one aspect of the invention, there is provided a system for providing treatment to a patient with a mental illness, the treatment system including:

a communication interface to receive electronically information relating to monitored behaviour of a patient; and

a voice instruction module having stored thereon at least one pre-defined voice instruction, the communication interface being operable to transmit electronically the voice instruction to the patient.

The treatment system may be in the form of a control station. The control station may be embodied, at least partially, by a computer system. In such case, the computer system may include the communication interface and the voice instruction module. The communication interface may include a receiving module and a transmitting module, respectively to receive a communication containing behavioural information and to transmit a voice instruction.

The communication interface may be in the form of a wireless communication interface, for example an RF (Radio Frequency) transmitter/receiver (e.g. Bluetooth), or a network or Internet connection interface (e.g. a GSM modem, WiFi modem, or the like). It is to be understood that in applications where the control station is relatively near to the patient (e.g. in a psychiatric ward), the communication interface need only transmit a signal over a relatively short distance, and therefore may be in the form of an RF transmitter/receiver. However, in applications with a control station is relatively far from the patient (e.g. when a patient has been released and is at home or otherwise roaming freely), the control station may need to transmit/receive across a telecommunications network to reach the patient, and the communication interface in such a case may therefore include a network interface. The communication interface may receive the behavioural information via an audiovisual stream across the Internet, for example in the form of the streaming media Web application.

The behavioural information may include visual information, to indicate what the patient is doing, and instead or in addition, the behavioural information may include aural information to indicate what the patient is saying or hearing. Therefore, the control station may include a display screen and a speaker respectively to display the visual information and to play the aural information.

The control station may be operable to store a plurality of pre-defined voice instructions. The voice instruction module may include a memory module (e.g. a hard disk drive) to store there are on the plurality of predefined voice instructions. The voice instructions may be stored in an electronic format, for example .mp3, .wav, or the like. In such case, the control station may include a user input device to receive a command from a control station operator to select one or more of the predefined voice instructions to transmit to the patient. In addition, the control station may include a microphone to receive a voice instruction from the operator of the control station for transmission to the patient. Therefore, in response to a control station operator observing particular patient's behaviour, the operator may enter a command which is received by the input device to select one of the predefined voice instructions, which is appropriate for the particular behaviour of the patient, for transmission to the patient.

The control station may include a mapping device to map or track movements of the patient. The present location of the patient may be mapped and/or historical movements of the patient may be mapped. The mapping device may be operable to receive communication from a GPS (Global Positioning System) module.

The control station may be operable to monitor a plurality of patients. Therefore, the control station may include a plurality of display screens, and the user input device may be operable to receive a command to select one or more patients to monitor from a plurality of patients.

The treatment system may include a monitoring device to monitor the behaviour of a patient. The monitoring device may be in the form of an electronic device which includes a module to monitor electronically and discreetly behaviour of the patient and a communication interface to transmit information relating to the monitored behaviour to the control station and in response thereto to receive electronically a voice instruction directed to the patient from the control station.

By discreetly is meant that the patient is generally unaware that he/she is being monitored, or at least it is not readily evident that he/she is being monitored. Thus, the monitoring device may secretly monitor the patient.

The monitoring module may include a camera, e.g. a video camera or WebCam, to monitor the visual behaviour of the patient. Instead, or in addition, the monitoring module may include a microphone to monitor the aural behaviour of the patient. Thus, the monitoring module may be arranged to monitor audiovisual aspects of the patient's behaviour.

The monitoring module may further include a speaker or transducer (e.g. a loudspeaker, earphones, or the like) to play the voice instruction to the patient. The speaker may be arranged such that the patient is unaware of its presence. Advantageously, the patient is unaware that the voice instruction came from the monitoring device.

The monitoring device may be in the form of a compact, stand-alone device, which is attachable to the person of the patient. For example, the monitoring device may, in use, be concealed with in a garment of clothing of the patient, for example embedded within a collar of a shirt or disguised as a piece of jewellery, e.g. a neck chain or wristwatch.

In another embodiment, the monitoring device may be fixed permanently or semi-permanently to a room or area to which the patient is confined. In such a case, the monitoring module may include a series of CCTV (closed-circuit television) cameras and microphones discreetly mounted to walls or other structures of the room or in area, for example a psychiatric ward. Then, the monitoring module may further include a directional loudspeaker or transducer to direct the voice command to the patient.

The communication interface may include a receiving module and a transmitting module. Further, the communication interface may be in the form of an RF transmitter/receiver or a network interface (e.g. a GSM modem, an Internet connection interface, or the like).

Unless otherwise defined, all technical and scientific terms used herein have the same meaning as commonly understood by one of ordinary skill in the art to which this invention pertains. In case of conflict, the present document, including definitions, will control. Preferred methods and materials are described below, although methods and materials similar or equivalent to those described herein can be used in the practice or testing of the present invention. All patent applications, publications and other references mentioned herein are incorporated by reference in their entirety. The materials, methods, and examples disclosed herein are illustrative only and not intended to be limiting.

The following examples are intended only further to illustrate the invention and are not intended to limit the scope of the invention.

Remote Voice Therapy:

The following needs and conditions of the patient justify the application of RVT and its computer system:

Learning how to perceive visual objects: Through RVT a patient can practice and create a link between visual apparatus, body movements, objects in surroundings and self. Objects and people are gradually described by the RV in a short repeated manner. The patient needs an opportunity to practice perceiving objects on a one-to-one basis.

Getting a feeling of own body and movements in space: RV as a remote motivator is used to describe, encourage and correct the movements of the patient in space. Each destination point in space is described while the patient learns the orientation in space. These destination points will increase with time allowing the patient to create a network of movements in space. There is a need to practice single isolated movements in a repeated manner in order to get feeling/sensation of his/her body parts and its movements. RVT role is to reduce the information burden by explaining the patient's own movements position and identification of objects in space.

A need for external/remote voice: The state of self-awareness and self-conciseness of a mentally ill patient may be damaged or destroyed, and thus self-control does not exist. It is not possible to listen and recognise one's own voice, as it would be also a danger of recalling one's own low self-image and the accumulated faulty perceptual images. Learning recognition of one's own voice comes gradually by communicating indirectly loudly and imitating the RV. The patient perceives that the RV is his own lost internal voice (as a part of self-awareness). Thus, there is an ultimate need for an external voice. There is a need for a voice to imitate (learning how to speak), a voice to waken the patient and to increase self-awareness.

Limited capabilities in simultaneous filtering of visual and auditory information: The patient cannot handle the simultaneous exposure to visual and auditory stimuli due to the limited information processing capacity which leads to information overload and further accumulation of the faulty perceptual images. There is no coordination between external visual or auditory source-monitoring and internal monitoring. It is impossible to follow auditory stimuli from reality as they are too complex. RVT use simple auditory stimuli which the patient can handle releasing the patient energy for handling the complex visual information processing. Receiving the signals of the remote voice takes less effort from the patient than receiving visual stimuli. Relearning visual perception demands fast, short fixation between self and an object in the vicinity in order to create a visual image. This activity is transferred to the next object thus becoming continuous and should not be interrupted. Learning new visual perception may be accompanied by intensive motor tension which results in further overloading of the whole perceptive system.

A need for similar pattern of speech and indirect communication: Establishing a communication link with the patient is possible through the same or similar pattern of speech. The RV is adjusted to the speech of the psychotic patient and is transmitted with frequency, pauses, short messages designed specifically for the impaired reception capability of patient. A patient cannot follow direct instructions or perform direct communication, as this reinforces a faulty perceptual system. There is little or no possibility for direct communication as it only reinforces present wrong perceptual and speech habits and influences gathering more disconnected visual images, which results in further complexity and demands more time for treatment and recovery. RVT helps in learning speech through repetition and imitation. It also provides a communication model for the patient to follow.

Voluntary movements of the visual apparatus: The patient use voluntary internal effort in moving stiff eye muscles, in order to retain flexibility of the visual apparatus as lateral vision is not possible without losing touch with oneself. In order to stop further gathering of faulty images the patient has to stop the eye movements which lead to its stiffness. This patient's action is supported by constant stimulation by remote voice, thereby helping in the stimulating eye movements. The remote voice sends messages at a pace and mode which the patient can handle and understand and also helps in releasing energy for practice of motor movement of visual organs. The stimulation by the remote voice and the developed habit to follow its guidance results in tension in the body. The body tension positively affects eye movement.

The remote voice assists as a memory builder: Pre-psychosis memory storage is difficult to recall; it is not possible to recall the memory storage of disconnected images of reality from recent perceptual processes as there is no self-awareness. There remains a constant danger of further gathering of disconnected images and retaining old perceptual habits. It is necessary gradually to wipe out the faulty memory storage by building healthy images through new perceptual habits. When the self-awareness reaches a certain level the patient recalls old memories and incorporates them into the new memory storage. RVT help the patient to build the memory storage with an appropriate external guidance.

The Role of Remote/External Voice as a Temporary Ego

The primary role of the RV is to substitute for loss of internal control and to play the role of a temporary ego. The patient experiences the remote/external voice as his or her own internal lost voice, internal lost control or a sign of thought. This external voice repeated loudly becomes the patient's internal voice, thought. The remote/external voice is felt as an extension of the patient's own voice and as a model for speech. The remote voice activates and stimulates a patient's self-awareness, internal will, energy and actions, which together as a united simultaneous and incremental continuous effort, assist in treating or curing mental illness. It is possible to achieve the feeling of RV as the patient's own temporary ego, as the patient is unable to ascertain the distance and direction of the remote voice. Thus, RV serves a role of a temporary ego and stops further gathering of images disconnected with self.

The role of the RV is also to build a positive self-image and stimulate positive emotions. The RV acts as a remote coaching providing a powerful influence in the building of self-consciousness in a real world environment. It acts to direct behaviour in positive way up to certain point until the patient is able to cope. It helps the patient to connect past, present and future. The patient must not be forced under remote guidance through the remote voice to walk in unfamiliar places, or to perform an action for which the patient is not ready.

Special Characteristics of Remote Voice (RV)

The RV may resemble the patient's voice and way of speaking although with a different purpose. The voice may be subtle, suggestive, convincing and warm. The RV may talk in a spontaneous and persuasive manner. The RV may imitate the patient's manner of speech taking into account certain aspects such as: speed, complexity, and modality. The short, repeated, RV transmitted at intervals assists in breaking down any perceived barriers between the patient and remote voice and catches the attention of the patient. The RV encourages patients to perform actions according to predefined tasks (see Remote Voice Program).

Different pitches and tones of voice may be necessary in order to attract and build attention and to remain connected. Different places for transmitting the remote voice can be used. The same message can be transmitted from the same place. Known voices of family members for the purpose of recognition can be recorded and transmitted occasionally.

Thus, remote voice should follow a pattern which the patient can follow (e.g. a simple message, repetitive, appropriate frequency, time intervals in transmission). By transmitting the remote voice or auditory signals in a particular way having specific characteristics, they should leave a trace and be remembered by the patient.

Initiation of Communication Through Remote Voice

Initiation of communication through RV can start in quiet areas where there is no disturbance from external auditory stimuli. Thus, it can be done through repetition at regular time intervals at the same places, transmitting a short message of short duration so that the patient is not interrupted in their regular activities. The message with repetition leaves a trace or is retained by the patient and the patient is stimulated and maintains attention.

Initiation of the communication link is a gradual process due to the negative influence of present perceptual habits. Basically, the patient, as a defense mechanism, stops eye movements in order to stop further reception of disconnected visual images (as there is no link with self). The pressure of gathered disconnected visual images creates a tendency to follow the specific sound of the remote voice.

The initiation of a remote message, for example, can be ‘I am listening, I can hear . . . I closed my eyes . . . [followed by the name of the patient]’. The remote voice plays the role of the patient's temporary ego by using the word ‘I’. The purpose is that the patient creates a feeling of the remote voice being his own voice.

This external voice link is the patient's only link with reality. Thus, the internal voice is missing, and there is a frantic need to hear one's own voice. Patients can only hear the voice similar to his or her own voice with a similar way of speaking that corresponds to his or her present needs and which is relevant to the limited motor and psycho energy.

The process of initiation of a link with the remote voice is also an awaking process and when a link is established it is visible through the patient's responses. For example, a response can be in a form of patient's loud repetition of remote voice messages, short answer to a message, stopping during a movement and listening, turning head, or performing an action as a response to a voice. These responses are performance indicators, which can be used to move to the next level of remote guidance.

Different aspects of Remote Voice Guidance

The patient under RVT can be guided for a couple of months or a few years.

There are certain aspects of guidance for which the remote voice is advantageous. There is no particular sequence, but the type of guidance depends on the stage of psychosis/schizophrenia, the specific needs of the patient in a particular circumstances. RVT scope is to cater for a wide range of guidance aspects and corresponding messages, for example:
Reinforcing the recognition of body parts and movements (for example, ‘it is my eye . . . I am moving my hand . . . I am smiling . . . I am going . . . I am sitting’).
Explaining, and/or confirming the patient actions in order to build self-awareness (for example, ‘I am right . . . be careful . . . don't go . . . the food is ready.’).
Explaining, encouraging the conversations (for example, ‘ . . . I want to tell . . . this is right . . . I am speaking . . . she is there . . . ’).
Building positive self-image, (‘I am clever . . . ‘I am pretty, I can talk . . . I[the name of the patient] . . . ’)
Encouraging the imitation, modelling of behaviour (for example, ‘ . . . I can dance . . . I can do better . . . let me repeat . . . ’).
Explanation of surroundings, the patient's position in space, objects, faces, paths, places (for example, ‘I am in the bathroom . . . where is the towel . . . look my face . . . . ’)
Encourage building the right perceptual habits (for example, ‘ . . . I can hear . . . I see . . . listen . . . ’).
Explaining events in the vicinity (for example, ‘be careful . . . cars . . . go this way . . . look for tall building . . . talk . . . ’).
Constructing a long-term goal (for example, ‘ . . . I want to be [followed by the name of desired profession] . . . I can succeed . . . I can work hard . . . ’).
Reminding about family members, past events (for example, remember . . . pause . . . [followed by the name and/or the voice of the family member; the name of known place . . . sounds of a familiar noise in a place]).
Encouraging the learning process of new skills (for example, ‘I am learning . . . I have a talent . . . I am great . . . I am quick . . . ’).

The Patient's Name as a Powerful Tool in Building Self-Awareness

The process of building self-awareness through remote guidance is reinforced by calling out patient's name to reduce the influence of the existing negative self-image. The patient's name is closest to him (it connects to the memory storage of all previous information before psychosis/schizophrenia). Self-awareness increases with the repetition of remote words and phrases by hearing one's own name. The name can remind, guide in the recognition of body parts, movements, objects, events, and the patient previous history.

The patient's own name must be transmitted in a very short time (milliseconds), and in such way that the sound of the name does not interfere with patient's actions.

Thus, remote messages are reinforced by calling out the name of patient. Not every remote message is followed by the patient's name as it would lead to overloading and counters to the principle of gradual self-awareness. The remote voice can transmit only the patient's name at appropriate time intervals to maintain the gradual awakening process. Calling the name helps in the transition process from previous perceptual habits to new ones, which influence the process of replacing old partial, received visual images with new ones.

The awakening process is gradual as remote messages are received superficially not in depth. The aim is to achieve breadth at the expense of depth. The process of self-awareness is simultaneous with the gradual learning of visual perception. The patient has to create a simultaneous link between self [own name], body, motor movements and visual stimuli.

The patient's name is a central link in connecting and storing information into the memory base. Information stored in the patient's memory is not lost and can be retrieved when self-control increases through the recognition of one's own name. The patient must learn new ways to store and retrieve data as well as new ways to erase unnecessary data and connect them with self. This will be reinforced with the use of the patient name in an appropriate way. The use of the name in RVT is therefore a powerful remote tool, technique and memory builder.

Techniques of Transmission: Some Examples

As the patient loses self-consciousness and self-control of his own body movements, the patient must begin to learn as if he were a child. Relearning these processes is guided by the name calling technique. Remote messages can be for example in a form of associations or commands.

### EXAMPLE 1

### Learning Orientation in the Space and Explanation of the Patient Movements and Actions

A patient has a task to go and eat in a dining room. The patient is in the stage one. The patient cannot move or is very restless, cannot follow own movements, movements are quick or slow, without self-awareness. A remote voice can be transmitted at the room or outside in a passage telling the patient, for example, ‘I am hungry . . . I must eat . . . I must go . . . ’

When patient moves he must be given instructions where to go, for example, ‘where to go . . . I know . . . I must listen . . . go right . . . this way . . . I am going to eat . . . [the name of the patient is mentioned, very quickly]. Further messages in a dining room can be for example, ‘find a plate . . . I am eating . . . I like this food . . . go back to room . . . I must go back to my room . . . go.’

The patient must develop a link between an object and self which is supported by voluntary motor movements and an extreme body tension. In this way the patient creates a network of the links between self, body and the objects. These actions must be supported by the remote voice, for example, ‘I am looking . . . there is a wall . . . [name] . . . talk loudly . . . I am talking loudly . . . ’ Almost any action is confirmed and repeated with a word such as ‘I’.

### EXAMPLE 2

### Moving and Performing Actions in an Complex Environment

A patient obtains the task: locate a friend and the place of residence, visit the friend and return back to own accommodation place. If the patient makes a mistake a message must be transmitted, for example, ‘it is wrong way . . . remember these steps . . . go this way . . . ’ When the patient reaches the house, a remote message can instruct ‘knock on the door . . . here is [name of patient] . . . how are you? . . . I didn't see you for a long time . . . ’ ‘I am going back . . . here is the street’.

The messages of initiating movements in space are transferred gradually . . . continuously as the patient is moved with remote voice from a static position’ . . . remember, friend's name [name] . . . he is waiting for me . . . I must visit . . . tomorrow . . . I know the way . . . ’

### EXAMPLE 3

### Learning how to Speak with Remote Voice

A person approaches the patient but the patient doesn't recognise the face of the person. In that moment the remote voice encourages the patient to talk, for example, ‘ I am . . . How are you? . . . I haven't see you . . . ’ The patient repeats remote words and answer loudly (as talking to himself or herself), for example, ‘I am [name] . . . I am starting to talk . . . ’ Thus, patient imitates remote voice the way of speaking and its words.

The patient can learn how to speak with remote voice through the trial and error without the danger of direct communication. The patient in this way slowly develops thought process. For example, the patient answer the question sent by the remote voice‘ what am I doing? . . . I am walking . . . ’

Thus, the patient talks loudly to hear own voice and learn gradually to recognise own voice.

The patient's speech should be recorded in order to provide better remote guidance. The patient must be encouraged to talk loudly to ease the process of monitoring and prompt response from the remote voice. The patient must build his repertoire of words and meanings by repetition and practise.

If a patient does not talk the motor movements of speech apparatus disappear, and more effort and energy is needed for the recovery. Thus, remote voice, with its continuous influence, helps in maintaining motor movements of the speech apparatus.

The remote voice can be a command followed by the patient's acceptance, for example, ‘ . . . Be careful of the door, 1 [name] . . . I know I am . . . ’ Thus, the patient responds loudly to the remote voice, repeats words and starts to memorise what is being taught.

The remote voice helps the patient to repeat the right order of words, to allow intervals between words, to emphasise some words. The length of remote messages increases with the development of self-awareness.

### EXAMPLE 4

### Learning Visual Perception and Building Positive Emotions

The remote voice helps in learning visual perception, for example ‘I am here you are there . . . steps are right . . . the bus arrived . . . ’ The patient repeats the remote messages loudly and slowly it is built internally.

The quick, short fixation of each object in surroundings has to be done voluntarily accompanied with an extreme body tension and the supporting words in order to create a link between an object and self. But these actions are not in harmony, there is no time and no energy to perform simultaneously all these actions, so there is an ultimate need for remote guidance.

In addition the objects and faces in the perceptive field must be emotionally positively coloured. For example, a message can be transferred, ‘this is nice flower . . . he is a good . . . you are beautiful . . . I am happy . . . ’

### EXAMPLE 5

### Building of the Border Between Self and Reality

The recognition of the border between reality and the patient needs an extreme continuous effort with the constant repetitions of self awaking messages, for example ‘I am here, it is there . . . I am walking, you are there . . . I am sitting . . . it is far . . . ’ These words can aid the separation process between the patient and the object. At this time, the own voice sounds strange. These words are sent by the remote voice, which aims to establish gradual self-awareness and build the feeling of distance between the patient and reality. Thus, the remote voice contributes to the creation of a distance between the patient and reality.

When transmitting a remote message, time intervals/pauses must be provided in order for the patient to respond. For every action a voice message is repeated few times until the patient reacts and repeats the same action few times more or less successfully. The patient listens to the remote voice which is gradually perceived as the patient's own voice, becomes alert and adjusts his own voice to the external/remote voice speed, modulation, and the frequency. Different voices can be recorded to widen the diversity of the learning.

When to Terminate the Remote Voice:

RVT is used frequently until the patient shows signs of self-awareness and the ability to talk (stage one and two). In the stage three there will be no need to build further skills for example, the orientation in space, recognition of own body movements, recognition of own voice. At the stage three it is necessary to guide the patient in social settings for example, by allocating a role in the community, or by arranging places where the patient can work or study.

Signs of saturation with remote messages must be carefully monitored (see the remote voice programme), recorded and an appropriate action must be taken gradually to terminate the transmission of the remote voice. For example, some saturation signs are: the patient shows signs of avoidance of places where the remote voice transmits from; the patient can suddenly stop and show signs of listening with a negative response; the patient can start turning towards the sound of the remote voice; the patient can comment for example, ‘I know that’ . . . I am sure somebody knows me’ . . . Please stop that nonsense . . . ’; the patient can even feel and tell that he is being spied on, that somebody knows his state of mind. These signs of ‘overdose’ of remote guidance can be avoided if the patient is gradually taken from the remote guidance with the help of remote voice monitoring system (RVMS).

The Remote Voice Program (RVP) as a Basis for Remote Guidance:

The Remote Voice Program (RVP) forms a basis for remote guidance. The program is created and used to send voice instructions through the voice transmission device. The program is based on the constructivist theory of learning and it can be transferable to a therapeutic environment. At the beginning of the recovery process, the routes and places where the patient moves can be constructed. The programme provides a set of tasks and activities.

There must be a certain force to initialise the patient movements, to initiate the communication link, and to fight the patient's tendency to keep the status quo. The program has a particular structure with a number of components. Some components of the remote voice program (RVP) can be:
Assessment criteria (AC) form the standards against which performance will be judged. AC help to evaluate the processes (cognitive and behavioural).
Range statements (RS) include the critical areas of content, processes and context, which the patient should engage in.
Performance indicators (PI) provide details about the content and processes that a patient should master. PI dictates the frequency and type of remote guidance. For example, a performance indicator can be ‘returning promptly to the starting position without repetition’. This means that the patient's orientation in space is acceptable. Another example is ‘the way the patient responds to the remote voice’. There are number of non-visible indicators, for example ‘a number of visual images created by one-to-one visual fixation’.
Notional time (NT): “Notional time represents contact time, patients' efforts and time.
Case study tasks (CST) help the patient to develop the perceptual system, motor movements and speech in different places in the community.
Resource tasks (RT): Resource tasks are short practical activities which engage the patient's thinking processes and help to develop knowledge and skills
Capability tasks (CT) help the patient to demonstrate cognitive, psychomotor skills, knowledge, values and attitudes.
Activities (A) are allocated for each task.
Expert/operator activities (OA) helps in monitoring the patient and adjusting voice messages in accordance with the patient's performance.
Recorded voice messages (RVM) voice messages are created based on the patient's tasks and activities.

The individual remote programme is developed depending on the patient's history. The basic remote voice messages are similar to different patients particularly regarding the recovery of the perceptual system and motor movements. The RVP is particularly applicable for the first stage of psychosis when the patient is frequently guided by RV. The programmed voice messages set in RVP can be adjusted depending on the patient's recovery pace and situational factors.

Radio Voice Transmission System

Radio voice transmission system (RVTS) is the simplest device and form of transmission. A radio channel with short distance radio waves are created for the purpose of guiding the patient in different places. This system consists of an operator and a radio device equipped with speakers. An operator activates a tape or CD, which transmits programmed voice messages set in the Remote Voice Program (RVP). A particular voice message accompanies each task and activities. The transmission of the remote voice is adjusted by the monitoring process including observations. The patient's voice is recorded in order to determine the progress and the type of remote voice guidance. There is a need for frequent monitoring (on a daily basis) particularly when the patient is involved in learning how to speak.

The radio waves may be transmittable from place to place depending on the movements of the patient. The transmission process as well as the operator must be invisible. This transmission system is portable and can be used in a variety of situations. The system is not flexible in terms of fast adaptation of remote voice guidance. There are also issues regarding security features. Expert psychologist/psychiatrist help is not immediately available. The system is static, and needs additional technology to monitor the patient, to communicate with an expert and to change remote guidance.

Computer Networking Voice Transmission System

A computer voice transmission system (CVTS) is in the form of an online networking system including an operator, a psychologist/psychiatrist, patient(s) connected through an Intranet, and a web based environment. Additionally, secure connections can be placed on the web site and communications can involve large distances on the Internet.

An operator uses a computer/laptop/palmtop and activates RV through speakers, recorded on CD or placed into a secure database. The Remote Voice Program influences the content of remote messages which is designed by an expert psychologist/psychiatrist. An operator communicates frequently with an expert (clinical psychologist/psychiatrist) in the form of SMS, voice, e-mail messages using the online system placed on the Intranet or Internet. Camera(s) may be placed in certain places or a cell phone camera can capture the images of the patient. A software program controls sending the patient's images via camera(s) and recorded voices of the patient.

It is important to communicate with the expert and to send images and recorded voices of the patient, in order to determine the level of recovery. It is necessary to determine the next level of remote guidance or modifications of RV. A clinical psychologist/psychiatrist as an expert can monitor more patients on line and communicate remotely with patients with the help of the operator and the computer system.

This voice transmission system placed on a laptop/palmtop and managed by an operator must be invisible. There are two methods of the activation of this system:
First method is that an operator must be at different places a reasonable distance from the patient to activate RV using the system and the speakers.
Second method is that RV is sent online into a remote laptop/palmtop (which is placed at a reasonable distance from the patient) and activated by the operator remotely through the computer program. This method allows the guidance of more patients at the same time.

A remote voice web site (RVWS) and networking system are protected with passwords, thus security features are in place as well as ethical issues are considered.

The web site consists of the patient's history and the programme (RVP) and corresponding voice messages. Additionally, it has a map where the patient is moving at the present time and expected movements in the near future. A map is drawn for the first stage of psychosis/schizophrenia as the patient's movements can be predicted. Thus, learning routes can be predicted and the basic remote guidance is similar for different patients.

The patient is inclined to follow the routes where RV and corresponding system is installed. Why? The patient is frightened to visit places where remote guidance is missing. With time a number of routes and the patient's activities increase. The map must be updated and it can be used as an evaluation tool together with captured visual images and recorded patient's voice. The previous routes where learning took place (with the repetition) are deleted and new ones are added. The map of routes and places can be redesigned, as the patient will try to visit almost all the places where psychosis/schizophrenia developed in order to wipe out old visual images.

Voice transmission components, for example speakers can be activated remotely and the position of these can be indicated on the map for the purpose of planning and monitoring.

A remote voice therapy portal can be designed with a network of patients guided by the expert and activated by an operator. The operator might have a panel, which activates voice signals. Thus, a psychologist/psychiatrist can have a network of communications with patients through the main centre for remote guidance. In the near future it will be possible to design a remote voice resource planning system (RVRPS), which will contain all the processes and functionalities necessary to handle the RVT system.

The system can be activated in a library, a park, car, bus, house, and any place the patient is exposed during the recovery process. It must be used frequently (every day, every 15 min approximately) in the first stage of psychosis to satisfy the principle of continuity of learning.

A Synergy Between Human Resources and the Remote Voice System

Learning through RV can be reinforced through indirect modelling by a clinical assistant. Human resources can aid the RVMS in certain instances for example when there is a technological error and the process of recovery must be continuous with no interruptions. A clinical assistant can repeat movements, speech or actions, indirectly in the vicinity of the patient. At the stage one, remote message can be transmitted at a very close distance, as the patient doesn't feel the border between self and reality.

An example: a clinical assistant can come close to the patient not emphasising his own presence. The clinical assistant starts talking indirectly in a voice the patient can follow or starts talking loudly, repeatedly until the patient respond to words. The clinical assistant who transfers RV talks in a similar manner as the patient in order to establish a communication link. The words influence the patient to move, to act to speak spontaneously. The messages transferred from a clinical assistant must comply with the individual RVP and under the supervision of the expert.

When a border between reality and self is formed the direction, distance and even quality of remote voice must be changed as the patient still needs learning through indirect guidance. Additionally, when the patient's self-awareness increases it is necessary that a clinical assistant move away to a further distance in the space. A clinical assistant now needs the technology in order to continue with RVT.

Radio Voice transmission System (RVTS), the Computer Networking Voice Transmission System and The Transmission of Remote Voice with human resources should be used in the collaboration.

Positioning and Distance of Remote Voice System/Device

At the first stage it is necessary to create the right conditions for sending and receiving RV such as quiet places in nature, with little surrounding noise.

A voice transmission device can be placed in the vicinity of the patient, preferably at a position which the patient cannot detect. The device must be portable so if necessary can be moved. The impression must be created that RV comes from an undefined position in space.

The voice transmission device can be placed for example, in the room or in the passage, if the patient is still in the stage one. When the patient is encouraged to move outside the room (with the help of RV) to a certain point in the space, the remote device can be placed at an appropriate distance. The patient must be able to hear the voice, for example, ‘ . . . I am going to balcony . . . room is empty . . . I am going . . . [name]. At the balcony voice can say ‘so nice . . . it is fresh . . . I am brave . . . I walk . . . I can see . . . ’ The patient must repeat movements following the voice instruction and repeat word instructions.

The invention will now be further described, by way of example, with reference to the accompanying diagrammatic drawings, in which:

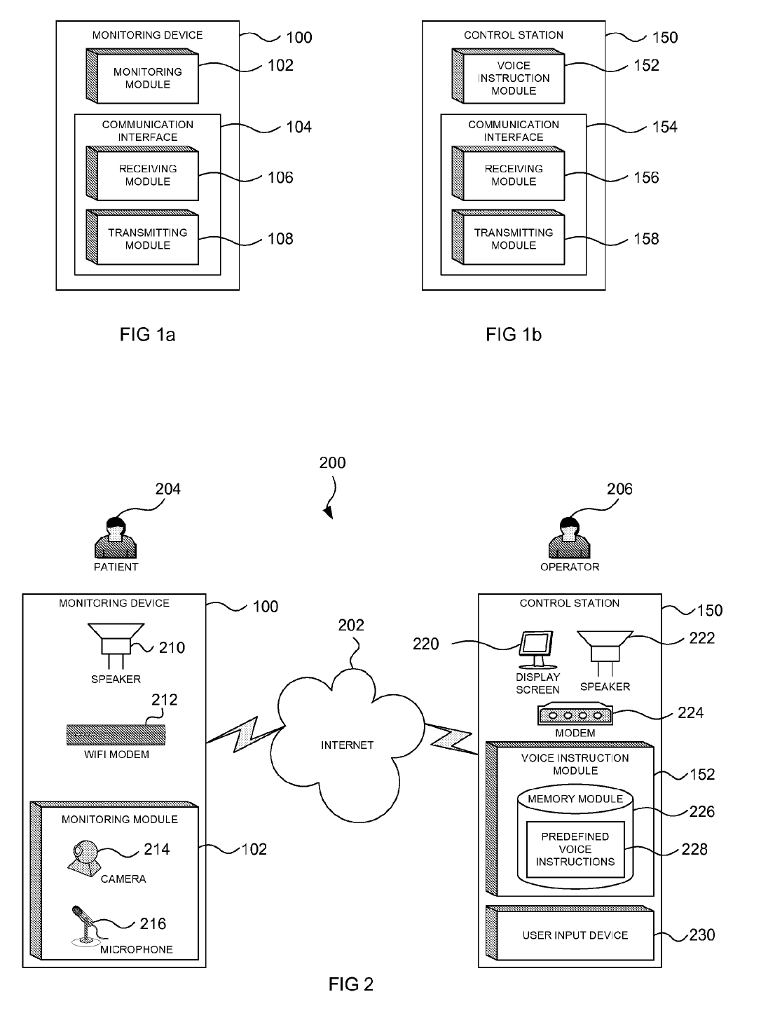

FIG. 1a shows a high-level schematic representation of a monitoring device in accordance with the invention;

FIG. 1b shows a high-level schematic representation of a control station in accordance with the invention;

FIG. 2 shows a low-level schematic representation of a monitoring system in accordance with the invention;

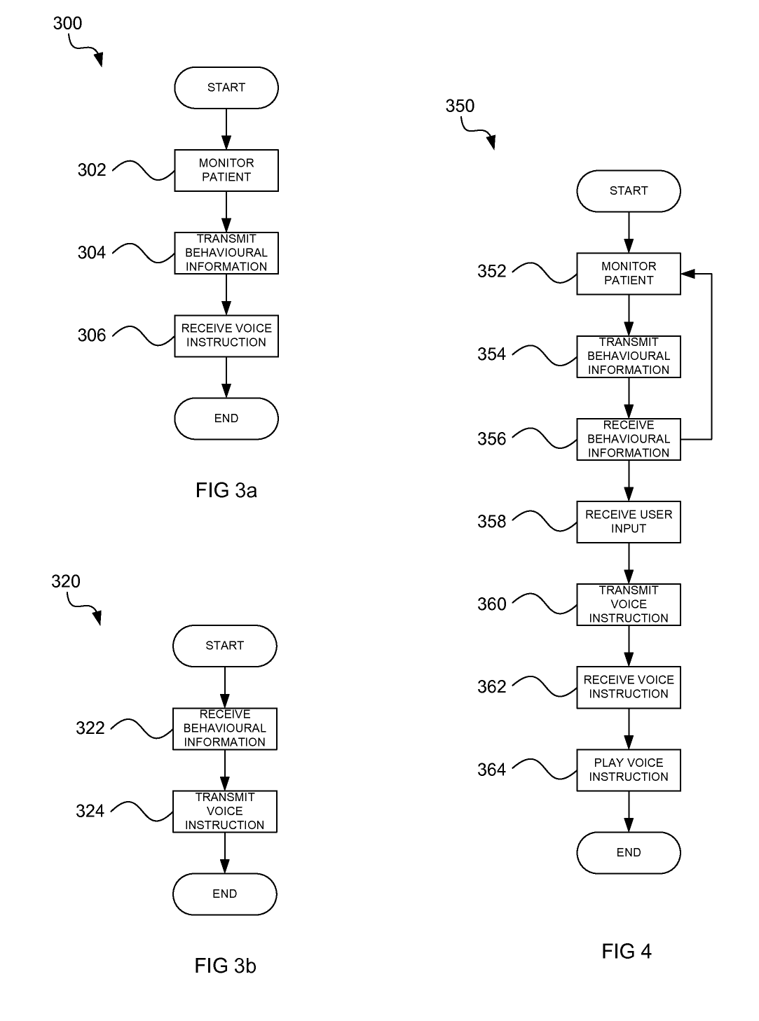

FIG. 3a shows a high-level flow diagram of steps of a method;

FIG. 3b shows a high-level flow diagram of steps of a method;

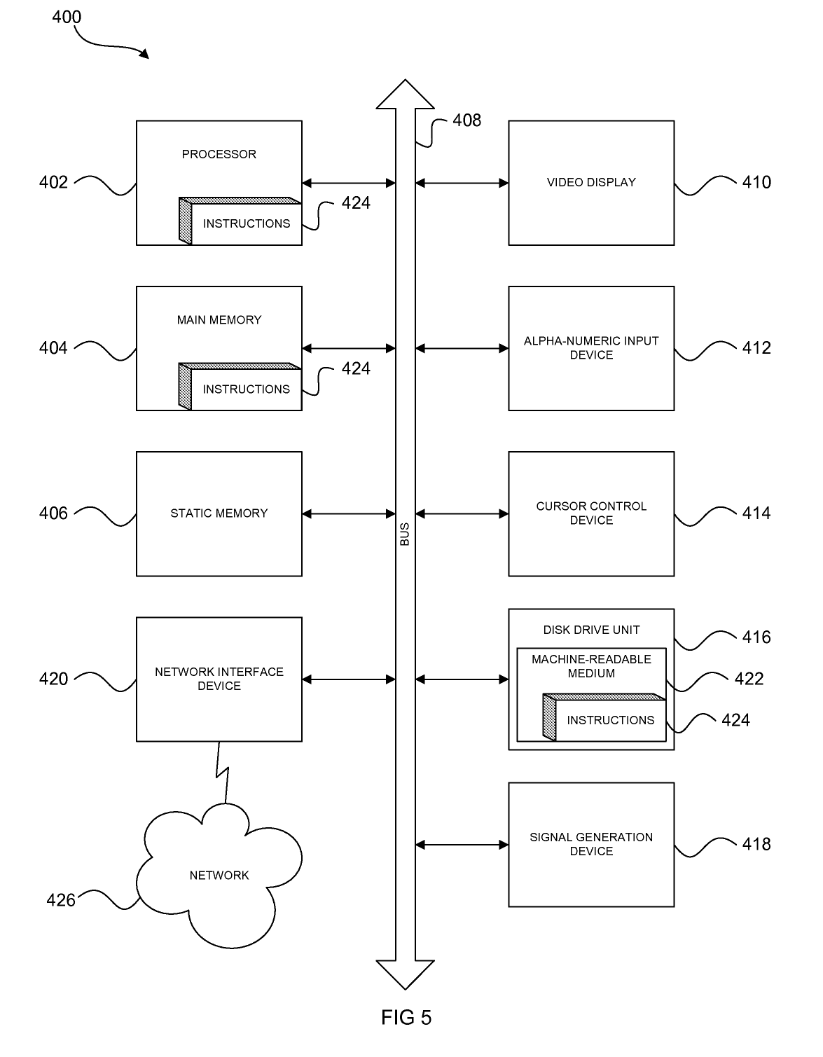

FIG. 4 shows a low-level flow diagram of steps of a method; and

FIG. 5 shows a schematic representation of machine in the example form of a computer system within which a set of instructions, for causing the machine to perform any one or more of the methodologies discussed herein, may be executed.

Referring to FIG. 1a, reference numeral 100 generally indicates a monitoring device in accordance with the invention. The monitoring device 100 includes a monitoring module 102 to monitor a patient undergoing psychiatric treatment. In addition, the monitoring device 100 includes a communication interface 104 which includes a receiving module 106 and a transmitting module 108, the modules 106 to 108 being conceptual modules which correspond to functional tasks performed by the communication interface 104. It is to be understood that the communication interface 104 may be embodied by a single device or apparatus which is operable both to receive and to transmit information or data.

Referring to FIG. 1b, a control station 150 in accordance with the invention is shown. The control station includes a voice instruction module 152 which is operable to store thereon predefined voice instructions or to receive a verbal voice instruction from an operator. Also, the control station 150 includes a communication interface 154 which includes a receiving module 156 and a transmitting module 158. The control station 150, in this example, is embodied by a computer system.

It is to be understood that together the monitoring device 100 and a control station 150 form a treatment system in accordance with the invention.

The communication interface 104 of the monitoring device 100 is matched to the communication interface 154 of the control station 150 for communication between the monitoring device 100 and the control station 150, either directly or via an intermediate network.

FIG. 2 shows a particular embodiment of a treatment system 200 in accordance with the invention. The system 200 includes the monitoring device 100 and the control station 150, which are shown in greater detail in FIG. 2. In this particular example embodiment, a psychiatric patient 204 is to be monitored and treated. The monitoring device 100 is therefore a portable, stand-alone device, which is attachable to the patient's person. The monitoring device 100 is small enough to be attached to the patient without the patient's being aware of such attachment. The monitoring device 100 is thus embedded or sewn into a shirt collar of the patient 204, without the patient's knowledge.

In another example embodiment which is not shown, the monitoring device may be permanently or semi-permanently installed in a building or premises. This will typically be the case when the monitoring device is installed in a psychiatric ward to monitor the behaviour of a plurality of patients whose movements are confined to the psychiatric ward.

However, referring back to FIG. 2, the monitoring module 102 of the monitoring device 100 includes a camera 214, to capture or monitor visual behaviour information of a patient 204, and a microphone 216, to capture or monitor aural behavioural information of the patient 204. The camera 214 is directed forwardly of the patient 204, so that the patient's changing field of vision can be observed. Instead, if desired, the camera 214 could be directed towards the patient's face, to give an indication of the patient's expressions and possibly of her surroundings. The microphone 216 is configured so that it picks up the patient's own voice, e.g. conversational speech, as well as voices and speech of others directed to the patient 204.

The monitoring device 100 includes a WiFi modem 212 (which therefore serves as a communication interface 104) for communication with a network, specifically the Internet 202. The WiFi modem 212 thus acts as both the receiving module 106 and the transmitting module 108, as it may both receive and transmit information or data via the Internet 202. The behavioural information is transmitted across the Internet 202 in the form of an audiovisual data stream.

Separate monitoring devices 100 are respectively attached to a plurality of patients 204 so that a single control station 150 may monitor the behaviour of a plurality of patients 204.

The control station 150, in use, is manned by an operator 206. The control station includes a modem 224 (which therefore functions as the communication interface 154, embodying both the receiving module 156 and the transmitting module 158). Via the modem 224, the control station 150 receives the behavioural information transmitted from the monitoring device 100. To this end, the control station 150 includes a display screen 220 and a speaker 222, respectively to display images or video captured by the camera 214 and to play audio captured by the microphone 216. The voice instruction module 152 includes a memory module 226, in the form of a hard disk drive, having stored there on a plurality of predefined voice instructions 228. A user input device 230 (for example a keyboard, mouse, touch sensitive display, or the like) is operable to receive user input from the operator 206. The operator 206 may thus select from the pre-defined voice instructions 228 an appropriate pre-recorded voice instruction via the user input device 230. The selected voice instruction is transmitted to the monitoring device 100 via the Internet 202 and played to the patient 204 on the speaker 210.

Although not shown, the control station is operable to monitor a plurality of patients, and the user input device 230 is thus also operable to select a particular patient to monitor, by displaying or playing behavioural information from the monitoring device 100 associated with the particular patient 204.

Referring now to FIG. 3a, a high-level flow diagram 300 of a method is shown, from the point of view of the monitoring device 100. The patient 204 is monitored, at block 302, by the monitoring device 100 by recording or capturing audiovisual behavioural information. The behavioural information is then transmitted, at block 304, to the control station 150 via the communication interface 104. A voice instruction may then be received, at block 306, from the control station 150.

Referring now to FIG. 3b, a high-level flow diagram 320 of a method is shown, from the point of view of the control station 150. Behavioural information about a patient 204 is received, at block 322, by the communication interface 154 from the monitoring device 100. A voice instruction is then transmitted, at block 324, to the monitoring device 100.

Referring now to FIG. 4, a low-level flow diagram 350 of a method is shown. The monitoring device 100 is attached to a patient 204 is to be monitored. Particularly, the monitoring device 100 is discreetly attached, for example by embedding the monitoring device 100 into a collar of the patient's garment, or by concealing the monitoring device 100 as an innocuous item, for example a wristwatch. Although a separate monitoring device 100 will be attached to a plurality of patients, for brevity, this example will be further described with reference to one patient 204 only. The patient 204 is allowed to roam outside of a hospital or psychiatric ward, for example in her apartment or going about her daily routine.

Once the monitoring device 100 is attached to the patient 204, the monitoring device 100 captures or records visual and aural information (respectively using the camera 214 and the microphone 216) about the actions and activities of the patient 204, thereby to monitor, at block 352, the patient 204. The monitoring device 100 continuously transmits, at block 354, an audiovisual stream of behavioural information to the control station 150 using the WiFi modem 212, for example in the form of a streaming audiovisual Web application. The audiovisual information is therefore transmitted across the Internet 202. The control station 150 receives, at block 356, the audiovisual behavioural information. The information is played on the display screen 220 and the speaker 222 so that the operator 206 can see and hear the patient's actions. It is to be understood that the method is continually repeated from block 352 to block 356 to monitor the behaviour of the patient 204 in real-time.

If the operator 206 deems it necessary, he may decide to issue a voice instruction to the patient 204. The voice instruction is designed to correct the behaviour of the patient 204 as part of patient treatment. For example, if the operator 206 observes the patient 204 engaging in unacceptable behaviour, or otherwise requires a voice instruction to be transmitted as part of treatment, the operator 206 will choose to issue a voice instruction (e.g., “don't do that”, “everything is okay”, etc) to the patient 204 to correct her behaviour. Therefore, the control station 150 receives, at block 358, a user input via the user input device 230, the operator selecting an appropriate voice instruction from one of a plurality of predefined and pre-recorded voice instructions 228 stored on the memory module 226. In response to receiving the user input, the voice instruction is transmitted, at block 360, by the modem 224 across the Internet 202 to the monitoring device 100. Correspondingly, the monitoring device 100 receives, at block 362, the voice instruction. The voice instruction is then played, at block 364, through the speaker 210 of the monitoring device 100. The patient 204 hears the voice instruction and might perceive it to be the “voice of reason”, causing the patient to behave or act in accordance with the voice instruction.

FIG. 5 shows a diagrammatic representation of a machine in the example form of a computer system 400 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420 utilizing any one of a number of well-known transfer protocols (e.g., HTTP).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The monitoring device 100 and/or the control station 150 may be in the form of computer system 400. Thus, for instance, in other embodiments, the monitoring device may be installed in a psychiatric ward. In such case, the monitoring device may take the form of a plurality of closed-circuit television cameras and one or more microphones. The monitoring device in this case will also include one or more directional speakers to direct the voice instruction to the patient. Thus, a plurality of patients in the psychiatric ward can be monitored using this monitoring device or arrangement by a single operator in the control station 150.

The Inventor believes that the invention as exemplified provides an effective method of and system for remotely monitoring a psychiatric patient 204, and in particular psychotic patients who might require external input to lead them along the path to recovery. Further, treatment of the patient 204 can be remotely administered via voice instructions. Thus, patients can be monitored and treated even after the release from hospital or psychiatric ward, thus aiding their integration into society.

A number of embodiments of the invention have been described. Nevertheless, it will be understood that various modifications can be made without departing from the spirit and scope of the invention.

1-48. (canceled)

49. A system for the treatment of a mental illness in a patient, said system including:
a patient system including a communication means for communicating a remote voice to a patient;
a clinician system located remotely from the patient system for monitoring and analyzing the remote voice treatment and to modify the remote voice treatment based on the analysis where necessary thereby to provide therapeutic treatment to the patient;
wherein the patient system and the clinician system are in signal communication with eachother the clinician system being a clinician computer workstation;
wherein said system for the treatment of a mental illness includes a monitoring means in the form of a separate monitoring device to monitor the behavior of a patient or plurality of patients, which is connectable in signal communication with the clinician system;
wherein the system for the treatment of a mental illness includes a communication interface to electronically receive information relating to monitored behavior of a patient and a voice instruction module having stored thereon at least one pre-defined voice instruction, said communication interface being operable to electronically transmit the voice instruction to the patient; and,
wherein the said system for the treatment of a mental illness is in the form of a control station, and control station is embodied, at least partially, by a computer system and wherein the computer system may include the communication interface and the voice instruction module.

50. The system as claimed in claim 49, wherein the communication interface includes a receiving module and a transmitting module, respectively to receive a communication containing behavioral information and to transmit a voice instruction and wherein the communication interface is in the form of an RF transmitter/receiver, a network and/or Internet connection interface, a wireless communication interface or combination of two or more listed forms.

51. The system as claimed in claim 49, wherein the communication interface receives behavioral information via an audiovisual stream across the communication interface; and wherein the behavioral information includes aural information to indicate what the patient is saying or hearing and the visual information of the patient to indicate what the patient is doing.

52. The system as claimed in claim 49, wherein the control station is operable to store and process a plurality of pre-defined voice instructions.

53. The system as claimed in claim 52 wherein the control station includes a user input device to receive a command from a control station operator to select one or more of the predefined voice instructions to transmit to the patient.

54. The system as claimed in claim 52, wherein the control station includes a mapping device to map or track movements of the patient.

55. The system as claimed in claim 49, wherein the monitoring device is in the form of an electronic device which includes a module to monitor electronically and discreetly behavior of the patient and a communication interface to transmit information relating to the monitored behavior to the control station and in response thereto to receive electronically a voice instruction directed to the patient from the control station, where said monitoring module includes a camera, a microphone, a speaker or transducer.

56. The system as claimed in claim 49, wherein the monitoring device is in the form of a compact, stand-alone device, which is attachable to the person of the patient or is fixed permanently or semi-permanently to a room or area to which the patient is confined.

57. The system for providing treatment as claimed in claim 49, wherein the communication interface is a hidden interface using digital, mobile and/or an RF transmitter/receiver for monitoring behavior of the patient.

58. A method of treating a mental illness of a patient that includes the steps of:
treating the patient's mental illness condition by means of remote voice system tailored to provide appropriate auditory stimulus to the patient;
monitoring and analyzing the treatment by means of remote voice system while it takes place; and,
modifying the treatment appropriately based on the analysis of the treatment.

59. The method of treating a mental illness as claimed in claim 58, wherein the remote voice system permits reassurance and self-healing in the patient who is diagnosed as having a mental illness.

60. The method of treating a mental illness as claimed in claim 58, wherein the remote voice is broadcast by a remote voice system, which imitates programmed words and short messages aimed in guiding the patient in the recovery process.

61. A system for providing treatment to a patient with a mental illness, the treatment system including:
a communication interface to receive electronically information relating to monitored behavior of a patient; and
a voice instruction module having stored thereon at least one pre-defined voice instruction, the communication interface being operable to transmit electronically the voice instruction to the patient;
a treatment system in the form of a control station;
a control station embodied, at least partially, by a computer system and wherein the computer system may include the communication interface and the voice instruction module;
a communication interface includes a receiving module and a transmitting module, respectively to receive a communication containing behavioral information and to transmit a voice instruction;
a communication interface receives behavioral information via an audiovisual stream across the Internet; and
behavioral information including aural information to indicate what the patient is saying or hearing.

62. The system for providing treatment as claimed in claim 61, wherein the control station includes a user input device to receive a command from a control station operator to select one or more of the predefined voice instructions to transmit to the patient, the control station storing a plurality of pre-defined voice instructions.

63. The system for providing treatment as claimed in claim 61, wherein the control station may include a mapping device to map or track movements of the patient, the control station operable to monitor a plurality of patients.

64. The system for providing treatment as claimed in claim 61, wherein the treatment system includes a monitoring device to monitor the behavior of a patient, wherein the monitoring device is in the form of an electronic device which includes a module to monitor electronically and discreetly behavior of the patient and a communication interface to transmit information relating to the monitored behavior to the control station and in response thereto to receive electronically a voice instruction directed to the patient from the control station, the monitoring device including a camera, a microphone, a speaker or transducer.

65. The system for providing treatment as claimed claim 64, wherein the monitoring device is in the form of a compact, stand-alone device, which is attachable to the person of the patient or is fixed permanently or semi-permanently to a room or area to which the patient is confined.

66. The system for providing treatment as claimed in claim 61, wherein the communication interface includes a receiving module and a transmitting module, the communication interface being in the form of an RF transmitter and/or receiver or a network interface and the communication interface being a hidden interface using digital, mobile and/or radio waves for monitoring behavior of the patient.
